(19) United States
(12) Patent Application Publication
(10) Pub. No.: US 2015/0028990 A1
(43) Pub. Date: Jan. 29, 2015

(54) SAFETY SWITCH WITH OVER-CURRENT PROTECTION

(71) Applicant: Albert HUANG, TAIPEI (TW)

(72) Inventor: Albert HUANG, TAIPEI (TW)

(21) Appl. No.: 13/950,025

(22) Filed: Jul. 24, 2013

(51) Int. Cl. H01H 77/02

(52) U.S. Cl. CPC H01H 77/02
USPC 337/12

(57) ABSTRACT

A safety switch with over-current protection has a switching button pivotally mounted on a housing. A linking member is pivotally mounted on one end of the switching button, and is linked to the switching button to oscillate according to on and off states of the switching button. One end of the linking member corresponds to a conductive plate in the housing for connecting to a power loop. The conductive plate has a first electrical connection part and a second electrical connection part formed on two ends thereof. When the power loop has an over-current condition, the conductive plate is deformed by the generated heat such that the normally-closed electrode contact above the conductive plate bounces off to disconnect from the power loop for over-current protection. As fewer parts are needed, fast assembly and economical cost can be achieved upon production.

### BACKGROUND OF THE INVENTION

1. Field of the Invention

The present invention relates to a safety switch and, more particularly, to a safety switch with a switching structure for over-current protection.

2. Description of the Related Art

Fault or failure of power-consuming equipment is oftentimes caused by an abnormal condition in which current of the load goes beyond a specified current range. Such fault or failure generally harms human body or damages power-consuming equipment to a certain extent. Hence, widespread safety protection devices in the market are mounted on circuits and power-consuming equipment for the purpose of preventing current leakage and abnormal increase of current load.

Disclosed in Taiwan Utility Model Patent No. 210601, entitled “Switching structure of safety switch with over-current protection”, an improved switching structure as illustrated in FIG. 6 has a switching button 91, an insulating driving member 92, a body 93 with an open top, a hook connection member 94, and a pin 95.

The switching button 91 is hollow, and has an open bottom and a pivoting ear 911. The open bottom corresponds to the open top of the body 93. The pivoting ear 911 is formed inside the switching button 91, and has a through hole 912 corresponding to a pivot hole of the pivoting ear 911.

The insulating driving member 92 has a pivoting lug 921, a first boss 922, a resilient member 923, and a positioning block 924. The pivoting lug 921 is formed on and protrudes from a top of the insulating driving member 92, and has a pivot hole. The first boss 922 is formed on and protrudes from one end of the insulating driving member 92. One end of the resilient member 923 is sleeved around the first boss 922. The positioning block 924 is connected with the other end of the resilient member 923. The positioning block 924 has a second boss 925 formed on an inside surface of the positioning block 924 for the other end of the resilient member 923 to be sleeved around the second boss 925.

The body 93 has a sink 931, a first terminal, a second terminal, a third terminal, and a conductive plate 932. The sink 931 is formed in the body 93. Two pivot holes are formed through two opposite walls of the sink 931 for the switching button 91 to be pivotally mounted in the pivot holes. The first terminal, the second terminal, and the third terminal are mounted on a bottom of the sink 931 to electrically connect to a power loop. The conductive plate 932 is flexible and is mounted inside the sink 931. One end of the conductive plate 932 is fixed on the first terminal, and the other end of the conductive plate 932 is connected to the second terminal. The hook connection member 94 pivotally holds the end of the conductive plate 932 adjacent to the second terminal, and has a round hole 941 and two arms 942. The round hole 941 is formed through a top end of the hook connection member 94. The two arms 942 are formed on and protrude from a bottom end of the hook connection member 94 toward the conductive plate 932 to hold a free end of the conductive plate 932 within a gap formed between the arms 942.

The pin 95 is mounted through the through hole 912 and the pivoting ear 911 of the switching button 91, the pivoting lug 921 of the insulating driving member 92, and the round hole 941 of the hook connection member 94 to pivotally couple the switching button 91, the insulating driving member 92, and the hook connection member 94 together. After the switching button 91, the insulating driving member 92 and the hook connection member 94 are mounted inside the body 93, the two arms 942 of the hook connection member 94 achieve to link the conductive plate 932. When an over-current event occurs in the power loop, the conductive plate 932 is deformed to bounce off the second terminal and form an open-circuited state. One end of the insulating driving member 92 is taken as a point of rest to change a switching condition of the insulating driving member 91 in collaboration with the elasticity of the resilient member 923 so as to attain the purpose of over-current protection.

Although the linking relationship formed by the multiple parts of the conventional switching structure realizes the safety protection for the over-current power loop, the multiple parts lead to higher production cost, and the assembling processes are also complicated such that the conventional switching structure is structurally complicated, fault-prone, and it is difficult to do the trouble-shooting.

### SUMMARY OF THE INVENTION

An objective of the present invention is to provide a safety switch with over-current protection with simplified structure and linking relationship.

To achieve the foregoing objective, the safety switch with over-current protection has a housing, a switching button, a linking member, and a conductive plate.

The housing is hollow, and has a chamber formed through a top of the housing and defined in the housing.

The switching button is pivotally mounted in the chamber of the housing and has an open bottom and a pivot shaft. The pivot shaft is formed on an inner wall of the switching button, and the inner wall protrudes downwards and beyond the open bottom.

The linking member takes the form of a slender plate, and is pivotally mounted on the pivot shaft of the switching button for the linking member to oscillate together with the switching button.

The conductive plate is slender, is mounted inside the housing, and has two electrode contacts formed on two ends of the conductive plate. One of the electrode contacts is connected to a lower portion of the linking member.

When the safety switch is applied to a power loop and the conductive plate is deformed by the heat generated by an over-current condition in the power loop, one end of the conductive plate bounces off and the power loop is switched to an open-circuited condition. The linking member is simultaneously linked to the conductive plate to change the switching state of the switching button. The power loop can be promptly disconnected for safety protection of the connected circuits and power-consuming equipment. With reduced parts involved, easy assembly and economical production cost can be ensured.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a safety switch with over-current protection in accordance with the present invention;

FIG. 2 is an exploded perspective view of the safety switch in FIG. 1;

FIG. 3 is another exploded perspective view of the safety switch in FIG. 1;

FIG. 4 is an operational side view of the safety switch in FIG. 1;

FIG. 5 is another operational side view of the safety switch in FIG. 1; and

FIG. 6 is an exploded perspective view of a conventional safety switch.

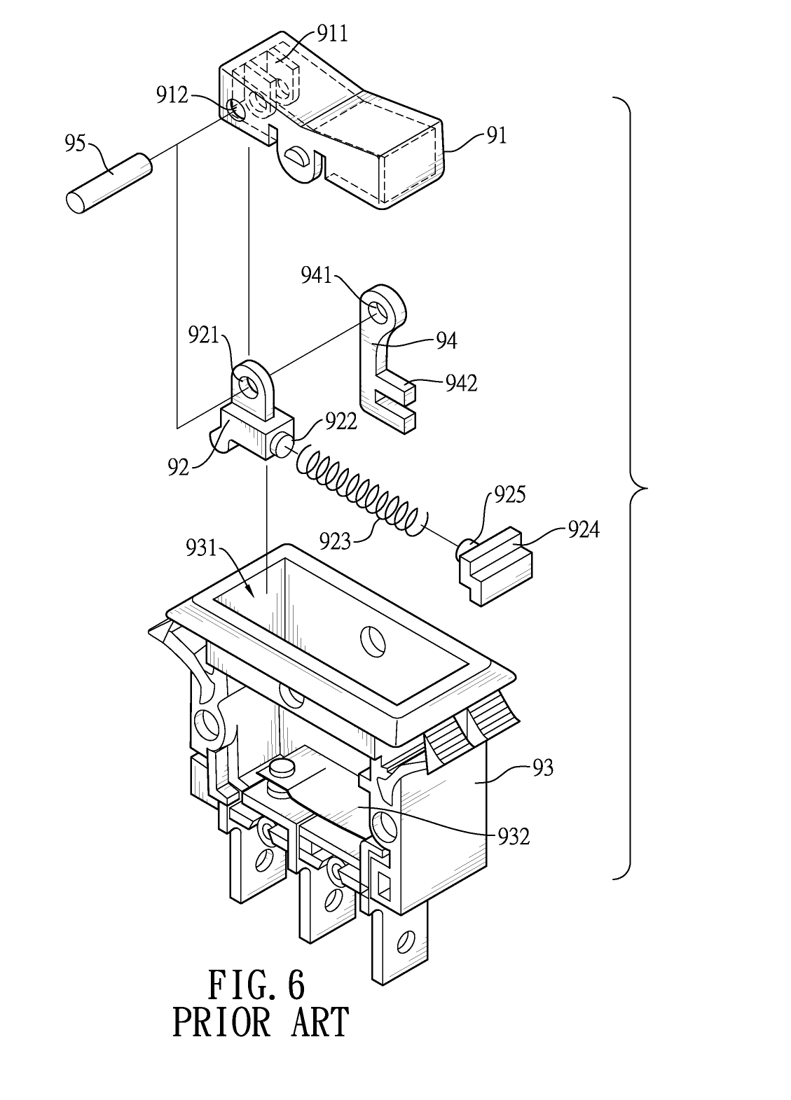

### DETAILED DESCRIPTION OF THE INVENTION

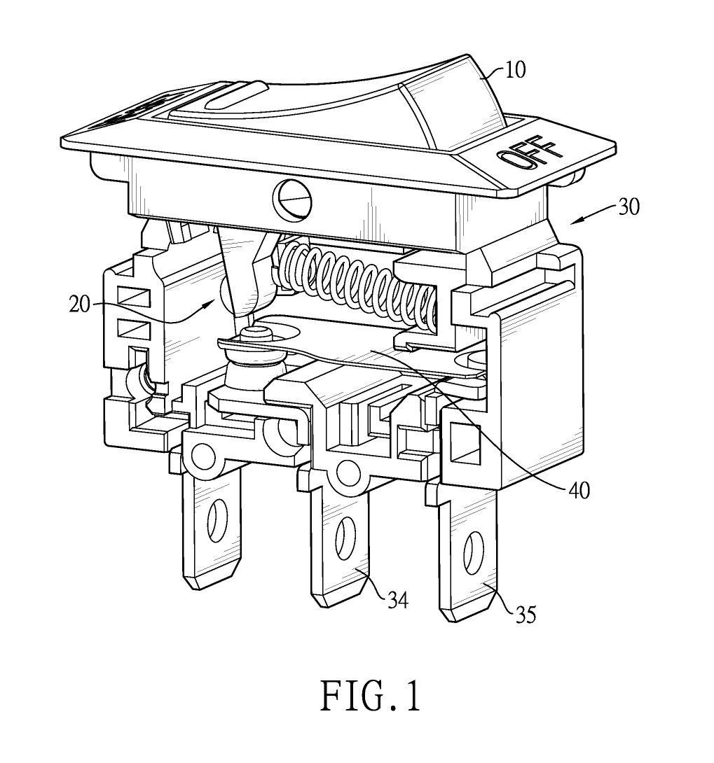

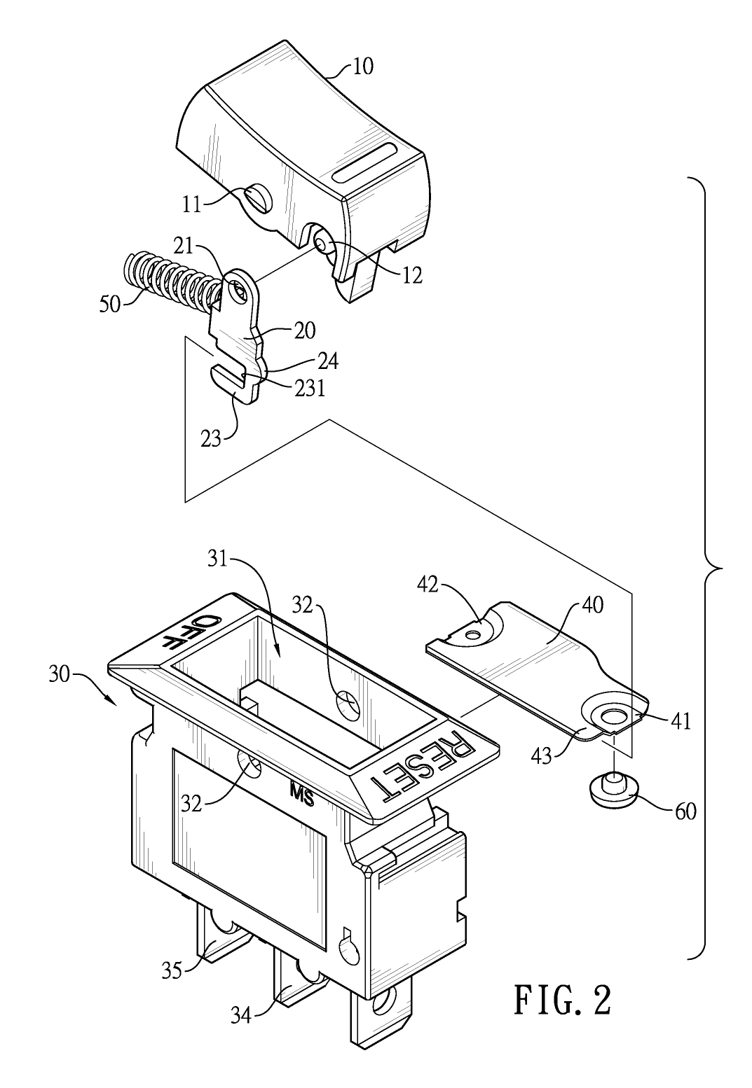

With reference to FIGS. 1 and 2, a safety switch in accordance with the present invention has a housing 30, a switching button 10, a linking member 20, a conductive plate 40, and a resilient member 50.

The housing 30 has a chamber 31 formed through a top of the housing 30 and defined in the housing 30. In the present embodiment, the housing 30 further has two boss holes 32 and a slot 33. The two boss holes 32 are respectively formed through two opposite inner walls of the chamber 31. The slot 33 is formed in another inner wall of the chamber 31.

The switching button 10 is elongated, takes the form of a rocker switch, is pivotally mounted in the chamber 31 of the housing 30, and has an open bottom. In the present embodiment, the switching button 10 has two bosses 11 and a pivot shaft 12. The two bosses 11 are respectively formed on and protrude outwards from two opposite longitudinal sides of the switching button 10, and are pivotally mounted inside the housing 30 with the bosses 11 of the switching button 10 mounted in the corresponding boss holes 32. The pivot shaft 12 is formed on an inner wall of the switching button 10, the inner wall of the switching button 10 protrudes downwards and beyond the open bottom and is parallel with the bosses 11.

The linking member 20 takes the form of a slender plate in an upright fashion, is mounted inside the housing 30 and is opposite to the slot 33 of the housing 30, and has a pivot hole 21. The pivot hole 21 is formed through a top end of the linking member 20, and matches the pivot shaft 12 of the switching button 10 for the pivot shaft 12 of the switching button 10 to be pivotally mounted in the pivot hole 21 so that the linking member 20 is linked to the switching button 10 to oscillate together with the switching button 10 according to ON and OFF states of the switching button 10.

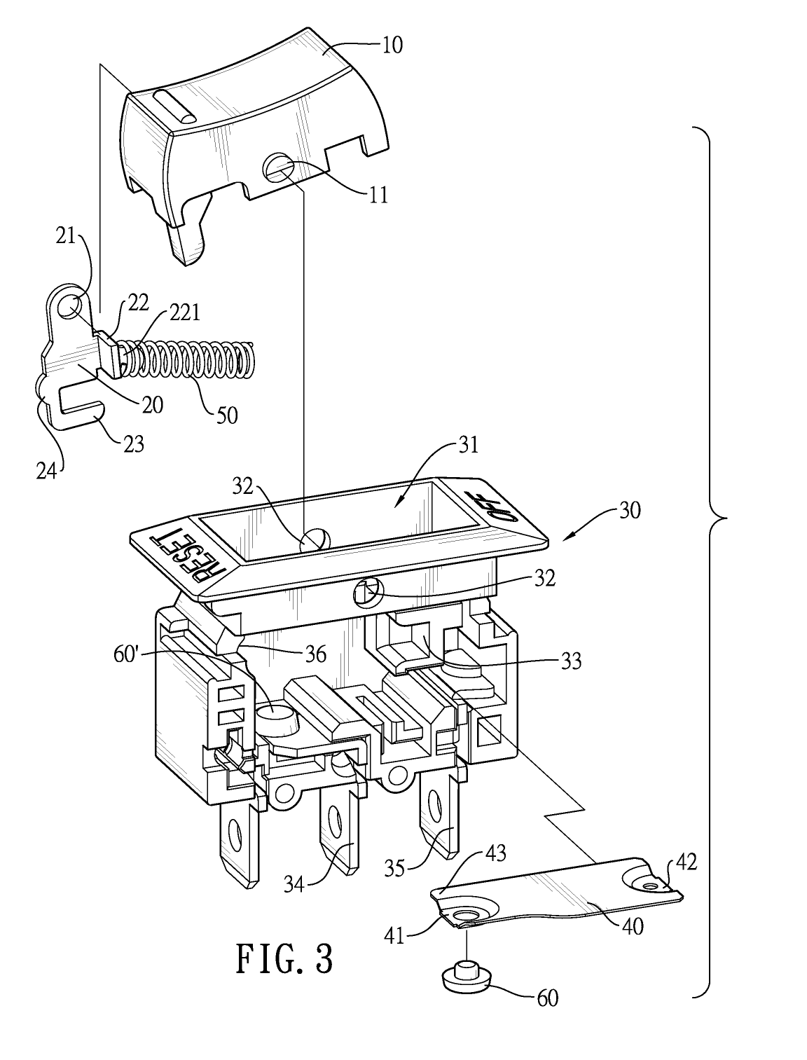

With reference to FIGS. 2 and 3, the linking member 20 further has a stopper 22. The stopper 22 takes the form of a rectangular plate, is formed on and protrudes laterally from an edge of the linking member 20, and has an inner side and an outer side, a nose 221, and a hook 23. The inner side and the outer side are opposite to each other. The nose 221 is formed on the outer side of the stopper 22. The hook 23 is C-shaped, is formed on and extends downwards from a bottom portion of the linking member 20, and has a groove 231.

In the present embodiment, the linking member 20 further has a protrusion 24 formed on a side of the linking member 20 proximal to an inner wall of the housing 30, and the housing 30 has an indentation 36 formed in the inner wall of the housing 30 to engage the protrusion 24. The housing 30 further has a first terminal 34 and a second terminal 35 mounted through a bottom of the housing 30 and electrically connected to electric wires of an electric appliance, power-consuming equipment, and the like.

The conductive plate 40 is slender and mounted inside the housing 30, and has two electrode contacts formed on two ends of the conductive plate 40. One of the electrode contacts is connected to a lower portion of the linking member 20. In the present embodiment, the conductive plate 40 has a first electrical connection part 41, a second electrical connection part 42, and a hook contact portion 43. The first electrical connection part 41 is formed on one end of the conductive plate 40 to correspond to a top end of the first terminal 34 and constitute a switching contact. The second electrical connection part 42 is formed on the other end of the conductive plate 40, and is securely mounted on a top end of the second terminal 35. The hook contact portion 43 is formed around the first electrical connection part 41 of the conductive plate 40, contacts the hook 23 of the linking member 20, and is held in the groove 231 to move up and down along with the linking member 20.

One end of the resilient member 50 is mounted around the nose 221, and the other end of the resilient member 50 is securely mounted inside the slot 33 of the housing 30. When the state of the switching button 10 is changed, the resilient member 50 exerts a resilient force on the linking member 20 for the protrusion 24 of the linking member 20 to engage the indentation 36 of the housing 30.

In the present embodiment, the safety switch further has two conducting pieces 60, 60′ respectively mounted on the first electrical connection part 41 and the first terminal 34 to constitute better electrical contact through the conducting pieces 60, 60′.

From the foregoing description, the switching button 10 is pivotally mounted on the housing 30, and forms a linking relationship with the linking member 20, and the hook 23 of the linking member 20 is connected with the conductive plate 40. When the conductive plate 40 is deformed by an over-current condition, the first electrical connection part 41 of the conductive plate 40 bounces off the first terminal 34, and the switching state of the switching button 10 is changed by the motion of the linking member 20.

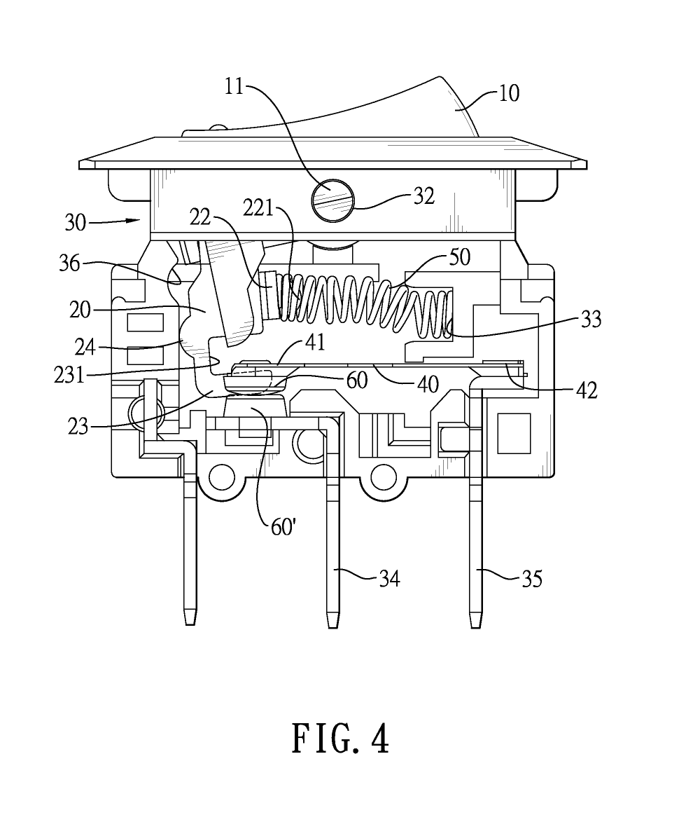

Operations concerning switching on and off the safety switch are described as follows. With reference to FIG. 4, when the safety switch is switched on and is connected to a power loop, the switching button 10 is pressed down so that the linking member 20 is moved downwards, and an inner wall of the groove 231 abuts against the first electrical connection part 41 of the conductive plate 40 and forces the first electrical connection part 41 to go down. Meanwhile, the resilient member 50 also exerts a downward acting force on the linking member 20 for the conducting piece 60 of the first electrical connection part 41 to electrically contact the conducting piece 60′ and further connect to the power loop.

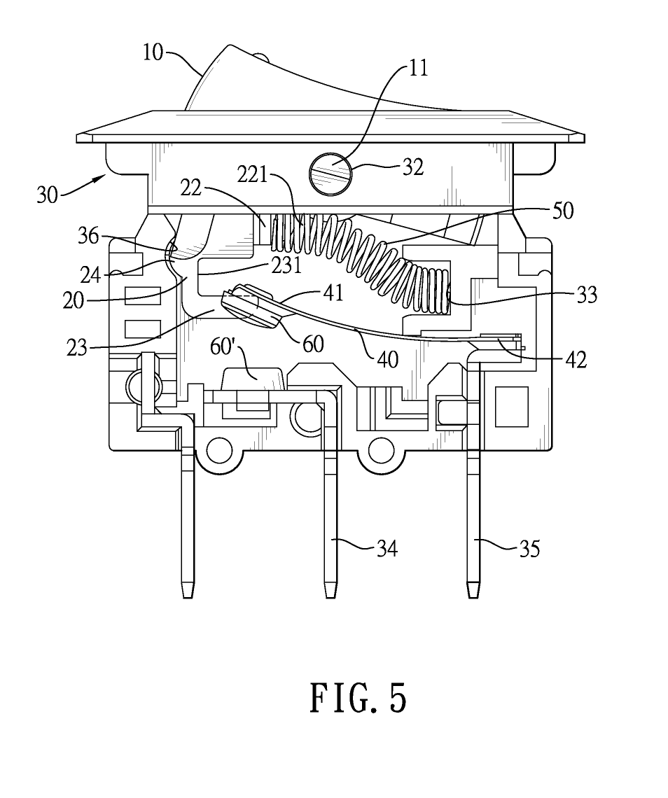

When an over-current condition occurs in the power loop, the conductive plate 40 is deformed by the generated heat. With reference to FIG. 5, the deformed conductive plate 40 is bent upwards to abut against and lift up the linking member 20 such that the linking member 20 is moved upwards. The resilient member 40 is also deformed because of the motion of the linking member 20. When the protrusion 24 of the linking member 20 is moved to the indentation 36 of the housing 30, the protrusion 24 is pushed by the resilient force exerted by the resilient member 50 and is fixed in the indentation 36. Meanwhile, the hook 23 of the linking member 20 lifts up the first electrical connection part 41 of the conductive plate 40 for the conducting piece 60 of the first electrical connection part 41 to bounce off the conducting piece 60′ of the first terminal 34 such that the safety switch is switched off and the power loop is open-circuited to fulfill the safety protection when the power loop is in an over-current condition.

Fewer parts are required in the safety switch, and fast assembly and economical cost can be achieved upon production. Additionally, the groove 231 of the linking member 20 has enough space. Accordingly, when the switching button 10 and the pivotally connected linking member 20 are faulty, the groove 231 allows the conductive plate 40 to bounce off to cut off the power loop without being affected by the linking resistance force of the switching button 10, thereby further ensuring safety protection of the power loop.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A safety switch with over-current protection, comprising:
a housing being hollow, and having a chamber formed through a top of the housing and defined in the housing;
a switching button pivotally mounted in the chamber of the housing and having:
an open bottom; and
a pivot shaft formed on an inner wall of the switching button, wherein the inner wall protruding downwards and beyond the open bottom;
a linking member taking the form of a slender plate, and pivotally mounted on the pivot shaft of the switching button for the linking member to oscillate together with the switching button; and
a conductive plate being slender, mounted inside the housing, and having two electrode contacts formed on two ends of the conductive plate, wherein one of the electrode contacts is connected to a lower portion of the linking member.

2. The safety switch as claimed in claim 1, wherein the linking member has a stopper taking the form of a rectangular plate, and formed on and protruding laterally from an edge of the linking member, and the stopper has:
an inner side;
an outer side; and
a nose formed on the outer side of the stopper.

3. The safety switch as claimed in claim 2, wherein the linking member further has a hook formed on and extending downwards from a bottom portion of the linking member, and the hook has a groove connected to and linked to one end of the conductive plate.

4. The safety switch as claimed in claim 2, further comprising a resilient member having two ends, wherein one end of the resilient member is mounted around the nose of the linking member, and the other end of the resilient member is securely mounted inside the housing.

5. The safety switch as claimed in claim 3, further comprising a resilient member, wherein one end of the resilient member is mounted around the nose of the linking member, and the other end of the resilient member is securely mounted inside the housing.

6. The safety switch as claimed in claim 4, wherein the housing has a slot formed in an inner wall of the chamber opposite to the linking member for the other end of the resilient member to be securely mounted inside the slot.

7. The safety switch as claimed in claim 5, wherein the housing has a slot formed in an inner wall of the chamber opposite to the linking member for the other end of the resilient member to be securely mounted inside the slot.

8. The safety switch as claimed in claim 6, wherein
the housing further has a first terminal and a second terminal both mounted through a bottom of the housing; and
the conductive plate has:
a first electrical connection part formed on one end of the conductive plate to correspond to a top end of the first terminal; and
a second electrical connection part formed on the other end of the conductive plate, and securely mounted on a top end of the second terminal.

9. The safety switch as claimed in claim 7, wherein
the housing further has a first terminal and a second terminal both mounted through a bottom of the housing; and
the conductive plate has:
a first electrical connection part formed on one end of the conductive plate to correspond to a top end of the first terminal; and
a second electrical connection part formed on the other end of the conductive plate, and securely mounted on a top end of the second terminal.

10. The safety switch as claimed in claim 9, wherein the conductive plate further has a hook contact portion formed around the first electrical connection part of the conductive plate, contacting the hook of the linking member, and held in the groove.

11. The safety switch as claimed in claim 8, further comprising two conducting pieces respectively mounted on the first electrical connection part and the first terminal.

12. The safety switch as claimed in claim 9, further comprising two conducting pieces respectively mounted on the first electrical connection part and the first terminal.

13. The safety switch as claimed in claim 10, further comprising two conducting pieces respectively mounted on the first electrical connection part and the first terminal.
